(19) United States
(12) Patent Application Publication
(10) Pub. No.: US 2014/0003256 A1
(43) Pub. Date: Jan. 2, 2014

(54) SYSTEMS AND METHODS FOR PROVIDING DISCOUNTS BASED ON TELEPHONY ACTIVITY

(71) Applicant: Guy FIGHEL, Red Bank, NJ (US)

(72) Inventor: Guy FIGHEL, Red Bank, NJ (US)

(21) Appl. No.: 13/538,303

(22) Filed: Jun. 29, 2012

(51) Int. Cl. H04W 4/02

(52) U.S. Cl. 370/252

(57) ABSTRACT

Systems and methods are provided for deciding whether to provide discounted telephony services to a user of the IP telephony system. The systems and methods accomplish this, in part, by determining whether a user has satisfied certain criteria relating to telephony activity conducted by the user. More specifically, the systems and methods determine whether a user has sent or received telephony communications from a particular location during a particular time period. If so, the user is provided with a discount on the telephony services.

### BACKGROUND

The technology is related to systems and methods for providing discounts to users. More specifically, the technology relates to systems and methods for deciding whether to provide discounted telephony services to a user of an IP telephony system based on criteria related to sending/receiving telephony communications from one or more telephony devices.

Telephony devices, such as a mobile telephone, are capable of conducting telephony communication in a variety of ways. For example, many mobile telephones conduct telephony communications via a cellular telephony service provider or over a publically switched telephone network. Some telephony devices are also capable of conducting telephony communications via an Internet Protocol (IP) telephony system.

A user may be charged for conducting communications through an IP telephony system. For example, a phone call may be billed based on the duration of the phone call (e.g., 5 cents per minute or a number of minutes deducted from a monthly minute plan).

Certain service providers are capable of providing discounts for their services. However, many service providers do not offer incentive based discounts where a user can receive a discount if certain criteria are satisfied. Furthermore, many service providers do not coordinate discounts on their services with marketing partners, thus facilitating business for both the service provider and the marketing partner.

### BRIEF DESCRIPTION OF THE DRAWINGS

FIG. 1 is a system level representation of elements of a telecommunications environment;

FIG. 2 is a schematic diagram of a controller that may be used to practice one or more embodiments of the present invention;

FIG. 3 is a block diagram illustrating how user telephony devices located in one or more locations can conduct telephony communications;

FIG. 4 is a flowchart illustrating a method embodying the invention for deciding whether to provide discounted telephony services to a user of an IP telephony system;

FIG. 5 is a flowchart illustrating a first method embodying the invention for determining if one or more telephony devices are in a certain location;

FIG. 6 is a flowchart illustrating a second method embodying the invention for determining if one or more telephony devices are in a certain location;

FIG. 7 is a flowchart illustrating a third method embodying the invention for determining if one or more telephony devices are in a certain location; and

FIG. 8 is a block diagram of a discount unit embodying the invention.

### DETAILED DESCRIPTION OF THE TECHNOLOGY

In the following description, references are made to a user's or a customer's telephony device. This term encompasses many different telephony devices, including traditional cellular telephones and mobile telephony devices that have the ability to wirelessly communicate digital data. This term also encompasses mobile computing devices that include communications capabilities provided by either or both of a cellular transceiver and a wireless digital data transceiver. Examples of such devices include the Apple iPhone™, mobile telephony devices running the Android™ operating system, the Blackberry™ and mobile telephones running the Symbian operating system.

The following description also refers to telephony communications. This phrase is intended to encompass virtually any type of communication, including audio and video telephone calls, text-based and video-based messaging, and all other communications conducted with a telephony device or a computing device that is configured to communicate with an IP telephony system. This phrase also encompasses other forms of communications that may be carried over a traditional or IP telephony network.

The term “call” or “telephone call” is used in the following description for ease of reference, clarity and brevity. However, all of the systems and methods described below which involve handling, routing and terminating telephone calls would also apply to systems and methods of handling, routing and terminating other forms of telephony communications. Thus, the terms “call” and “telephone call” are intended to include other forms of telephony communications.

In some systems and methods embodying the technology, telephony communications are effected over a packet-based data network. Signaling that is conducted in the packet-based data network is preferably executed using Session Initiation Protocol (SIP). SIP is a popular communication protocol for initiating, managing and terminating media (e.g., voice, data and video) sessions across packet-based data networks that typically use the Internet Protocol (IP), of which Voice Over Internet Protocol (VoIP) is an example. The details and functionality of SIP can be found in the Internet Engineering Task Force (IETF) Request for Comments (RFC) Paper No. 3261 entitled, “SIP: Session Initiation Protocol” herein incorporated in its entirety by reference.

SIP establishes and negotiates a session, including the modification or termination of a session. It uses a location-independent address system feature in which called parties can be reached based on a party's name. SIP supports name mapping and redirection, allowing users to initiate and receive communications from any location. Of course, while SIP is a preferred protocol for establishing communications over a data network, other signaling protocols could also be used to perform the technology described herein.

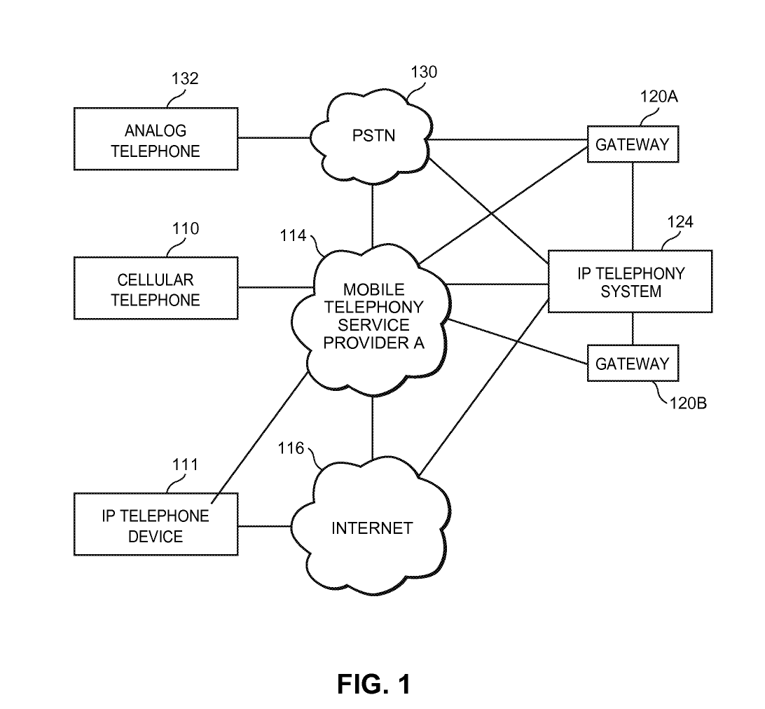

FIG. 1 depicts various elements of a communications environment which may be involved in terminating telephony communications to telephony devices. A traditional publically switched telephone network (PSTN) 130 allows an analog telephone 132 to place and receive calls. Likewise, a cellular telephone 110 can send and receive telephony communications through a mobile telephony service provider 114.

FIG. 1 further depicts an IP telephony device 111 that connects to a data network, such as the Internet 116. The IP telephony device 111 is provided with telephony service by an IP telephony system 124, which is also connected to the Internet 116. It should be appreciated that the IP telephony system 124 can connect telephony communications between the IP telephony device 111 and the analog telephone 132 and/or the cellular telephone 110 using the modes of communication for those respective devices. This is accomplished, in part, using gateways 120A and 120B that are capable of communicating with the PSTN 130 and the mobile telephony service provider 114, respectively.

The IP telephony device 111 may also include elements that allow it to communicate over the mobile telephony service provider 114, such as a cellular transceiver (not shown). Thus, the IP telephony device 111 may be capable of conducting telephony communications over multiple communications systems.

As will be described in more detail below, elements of the IP telephony system 124 are capable of providing discounts to users of the IP telephony system 124 when certain criteria are met. In particular, when the IP telephony system 124 receives information related to the time and/or place in which a telephony communication was performed, the IP telephony system 124 can decide whether to provide one or more users with a discount.

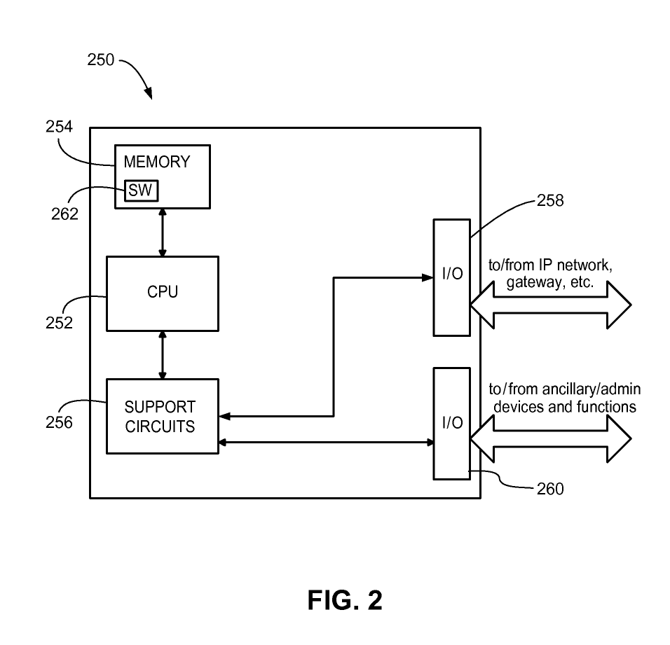

FIG. 2 illustrates elements of a computer processor 250 that can be used as part of the system operated by the IP telephony service provider 124 to accomplish various functions. The IP telephony service provider 124 could utilize multiple processors 250 located at various locations, along with their operating components and programming, each carrying out a specific or dedicated portion of the functions performed by the IP telephony service provider 124.

The processor 250 shown in FIG. 2 may be one of any form of a general purpose computer processor used in operating an IP based communication system. The processor 250 comprises a central processing unit (CPU) 252, a memory 254, and support circuits 256 for the CPU 252. The processor 250 also includes provisions 258/260 for connecting the processor 250 to customer equipment via one or more access points, such as the packet network 116, gateways 120A, 120B and a data channel provided by a cellular service provider, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

Another form of processor 250 that assists in execution and is otherwise part of the subject technology is found within one or more of the mobile telephony devices. Such devices are sufficiently advanced beyond early generation cellular telephones that they contain processors capable of running operating systems developed by device manufactures, as well as third party applications that are downloaded and installed by users to performing a myriad of communications and non-communications oriented tasks.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 124. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

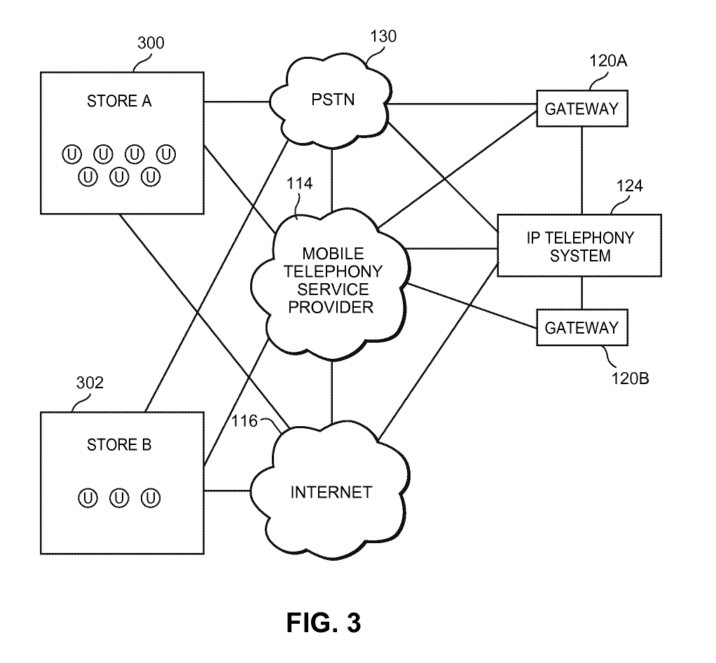

FIG. 3 shows a block diagram of an IP telephony system 124 communicating with one or more telephony devices located in two locations, Store A 300 and Store B 302, over one or more telephony networks. As described in more detail below, the present technology allows an IP telephony system 124 to establish a relationship with one or more partners who operate commercial and/or retail establishments. The IP telephony system 124 and the partner could then agree to jointly conduct a special promotion which is intended to drive customers to the commercial or retail establishment run by the partner, as well as to drive usage of the IP telephony system.

In particular, the technology could be used to conduct a special promotion where discounts are provided on telephony communications is users conduct telephony communications while at a business location of a partner. In some embodiments, the IP telephony system 124 and a partner would agree to publicize a special promotion where users who conduct a telephony communication through the IP telephony system 124 within a certain time period, and who do so while located in a commercial or retail establishment run by the partner, receive a discount on their telephony communications.

For example, a telephony service provider may run a promotion with a business such as a chain of coffee shops. Under the terms of the promotion, the telephony service provider would agree to offer discounts to its users for telephony services if the users conduct telephony communications through the IP telephony system while located at one of the coffee shops during given times of the day. For example, if the coffee shops non-peak hours are between 7 PM to 10 PM, it may be advantageous to run a promotion to attract more customers during those hours. Using the disclosed technology, the coffee shops could partner with the IP telephony system to run a promotion where users conducting telephony communications through the IP telephony system while located in a coffee shop during the hours of 7 PM to 10 PM would receive a discount on those telephony communications.

All parties potentially benefit from such a promotion. The users receive discounted communications services. The coffee shops may experience increased sales during off-peak hours if users show up to make use of the promotion. And the IP telephony system may end up carrying a greater amount of telephony communications for the users than would otherwise occur.

The IP telephony system can set up various criteria that a user must satisfy to qualify to receive a discount. In some instances, either sending or receiving a telephony communication from the stated location during the relevant time period may qualify the user to a discount. In other instances, the user may only receive a discount if the user sends a telephony communication, such as an outgoing telephone call.

The promotion might also be designed to appeal to a certain demographic. For example, the terms of the promotion may offer a discount to users who place a telephone call through the IP telephony system to a particular country or region. Such terms might draw a crowd of similar users who typically place telephone calls to that stated country or region.

In some instances, sending or receiving any form of telephony communication may entitle the user to a discount. In other instances, the user may have to place an outgoing telephone call to receive a discount. In still other instances, a user may be required to send one, or a certain number, of outgoing text messages.

It should also be appreciated that these types of promotions are not limited to commercial or retail establishments. Such promotions could also be conducted for at nearly any venue, including, but not limited to, restaurants, sporting venues, theatres, schools, and/or parks.

With respect to the criteria for running one or more promotions, various factors can be provided and configured in the IP telephony system. In addition to requiring that telephony communications be conducted at various specified locations, the time frame in which the communications are conducted may also be configured as one particular criteria. Using the example from above, the IP telephony system may be able to store the locations of multiple coffee shops, and may provide discounts on telephony services to those users that conduct telephony communications between the hours of 7 PM to 10 PM, Monday thru Friday. It should be appreciated that the time frame can be configured in a variety of ways, and is not limited to a period of hours or days. For example, the promotion can be offered on various holidays or the first Friday of every month.

Another example criteria could relate to the number of users present at a particular location when the calls are being placed. For example, for the users at the location to receive the promotional discount, a minimum number of users may need to be present, or a minimum of users may need to actually conduct a telephony communication from the location. Using the example above, if the minimum number of users required at a location is three, and only two users conduct a telephony communication from a coffee shop between 7 PM and 10 PM, then those users will not be able to receive the promotional discount on the telephony services.

Another example criteria could relate to further specifying the locations/stores in which the promotions may be run. Using the example above, instead of providing discounts for all coffee shops within a particular chain, discounts may be provided only for users that conduct telephony communications from those coffee shops in the chain that are location in a single city. Such a feature would thus provide local stores in a store chain with the ability to partner with an IP telephony service provider without having the promotion run at every store in the chain. It should be appreciated that many other criteria can be configured for running a particular promotion, and the criteria are not limited to the criteria mentioned above.

The criteria that are established under the terms of the promotion could include any number of terms. Those terms might be negotiated between the IP telephony system and the partner business so that certain types of customers are likely to be attracted to the business during the promotion. The above examples are in no way intended to be limiting. Any other terms, or combinations of terms, could be established to determine when a user is entitled to receive a discount.

FIG. 3 shows two stores, Store A 300 and Store B 302. Within each store, there are customers who may or may not be conducting telephony communications through the IP telephony system 124. For purposes of the following explanation, any customers who are conducting a telephony communication through the IP telephony system 124 are identified with a circle containing the letter “U.” Thus, FIG. 3 depicts that there are seven customers conducting a telephony communication through the IP telephony system in Store A 300, and three customers conducting a telephony communication through the IP telephony system in Store B 302.

Depending upon the type of promotion being offered, the number of users at a particular location who conduct telephony communications through the IP telephony system 124 may be relevant to satisfying the criteria for receiving a discount. For example, the promotion may require that at least 5 users must conduct a telephony communication through the IP telephony system 124 during a particular time period before any users will receive a discount. Similarly, the terms of the promotion may require that at least three users simultaneously conduct a telephony communication through the IP telephony system 124 during a particular time period before any users receive a discount.

As described in more detail below, the IP telephony system 124 can receive, determine and track various items of information about calls conducted by user telephony devices, and this information can be used to determine if the users have satisfied criteria that would entitle them to receive a discount. In particular, the IP telephony system 124 may receive and/or determine a location of a user's telephony device when a telephony communication was sent or received. The IP telephony system may also determine a time at which a telephony communication was sent from or received by a user telephony device. These items of information, and others, may be relevant to determining if the user is entitled to a discount under the terms of a promotion.

The IP telephony system may receive location information, such as latitude and longitude coordinates, reported from the user's telephony device. Many mobile telephony devices now include Global Positioning System (GPS) receivers that enable the telephony device to calculate and report its location.

As will be described in more detail below, the IP telephony system 124 may make use of other means to determine the location of a user's telephony device. For example, information from a cellular service provider 114 or other distributed communications systems may be used to triangulate a position of a user's telephony device. Also, the identity and location of a data network interface device through which a user's telephony device communicates over the Internet may be used to determine an approximate location of the user's telephony device.

In the following description, various processes are described with reference to a single user conducting a telephony communication using a single telephony device. However, it should be appreciated that the same processes apply to one or more users conducting one or more telephony communications using one or more telephony devices.

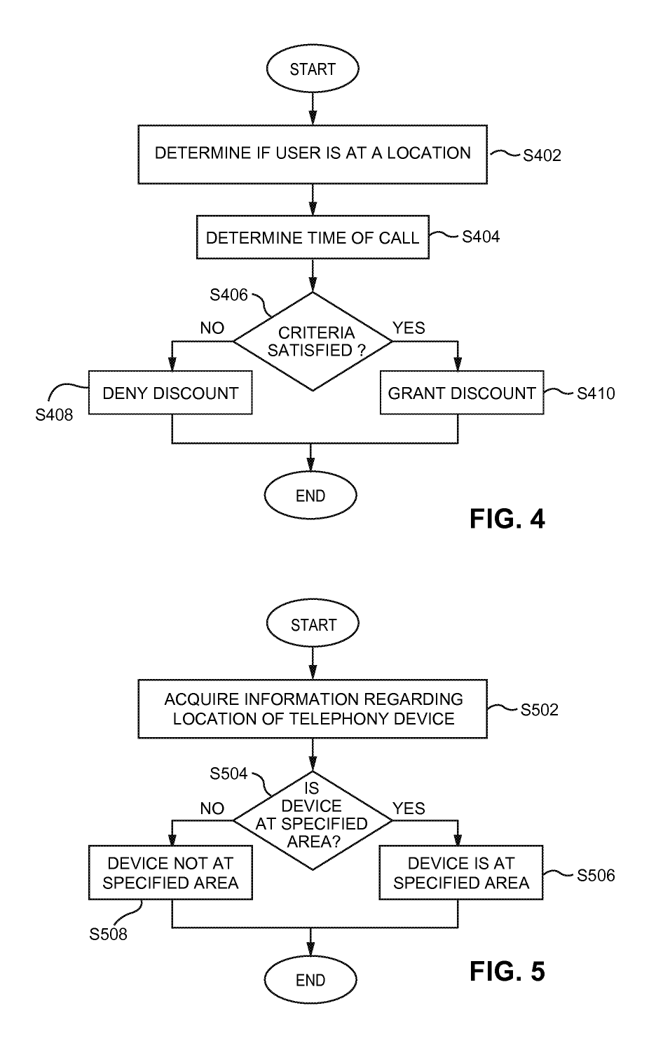

FIG. 4 illustrates a method for deciding whether to provide one or more users with discounts on telephony services. The processes shown in FIG. 4 can be implemented by the IP telephony system 124 where the IP telephony system can receive and process information from one or more user telephony devices, as well as information from other sources.

It should be appreciated that the IP telephony system can be configured to determine which locations/venues are going to run a promotion for discounting IP telephony services and the criteria for running the promotion. For example, the IP telephony system can be configured to select one or more stores for running a promotion and data relating to the location of the one or more stores can be provided. The location data can include geographical location data having latitude and longitude information relation to the location of the one or more stores. The location data might also relate to one or more IP addresses of one or more devices (e.g., a router) within the stores that enable the telephony devices to connect to the Internet to perform telephony communication.

The method illustrated in FIG. 4 is designed to determine if a telephony communication that is being conducted by a user's telephony device will satisfy the criteria entitling the user to a discount. The IP telephony system might conduct a method as illustrated in FIG. 4 any time that a user conducts a telephony communication through the IP telephony system.

The method begins in step S402, where the IP telephony system determines the location of the user's telephony device, and then compares that location to the geographical area or areas specified in the discount criteria. The IP telephony system then determines if the user's telephony device is conducting the telephony communication from within the geographical area or areas specified in the discount criteria.

Next, in step S404, the IP telephony system determines the time during which the user's telephony device is conducting the telephony communication, and the IP telephony system determines if the time falls within the time period specified in the discount criteria. It should be appreciated that a user can initiate the telephony communication by, for example, placing a phone call or sending a text message with the telephony device. Likewise, the telephony device itself may also automatically conduct the telephony communication. For example, an application on the telephony device may be designed to automatically conduct the telephony communication when the device is at a promotional location at a time when a promotion is running. It should also be appreciated that the IP telephony system may receive information from the telephony devices regarding the time and/or duration of the telephony communication, or the IP telephony system may independently determine the time and/or duration of the telephony communication.

In step S406, the IP telephony system determines if the discount criteria for the promotion are satisfied. If the criteria are not satisfied, the method proceeds to step S408, where the user is denied the benefit of the discount. If the criteria are satisfied, the method proceeds to step S410, and the user is granted the discount.

While the method illustrated in FIG. 4 could be used to determine if a particular call satisfies the discount criteria for a particular promotion, other methods could also be used to determine if users have qualified to receive a discount under the terms of one or more promotions.

For example, elements of an IP telephony system could review the billing records that are maintained for its users to determine if any of the users have qualified to receive a discount. As is well known to those of ordinary skill in the art, call detail records (CDRs) are recorded for each of the telephony communications that are conducted through the telephony system. In some embodiments, the IP telephony system could review a single user's CDRs for a time period such as a week or a month to determine if the user conducted any telephony communications during the time period that would entitle the user to a discount under any promotions that were active during the time period. The examination of the CDRs would determine if the user conducted any telephony communications from any locations involved in such promotions. If so, the times of those communications would be examined to determine if the communications occurred during the relevant time period(s) specified in the discount criteria. Thus, examining a user's CDRs in a batch format could determine if the user has conducted any telephony communications that would entitle the user to receive a discount.

In some embodiments, the CDRs for multiple users could be examined to determine if any of the users conducted telephony communications that would entitle the users to receive a discount under a single promotion. In this instance, it would only be necessary to examine CDRs for telephony communications that occurred during the time period specified in the discount criteria for the promotion. Those CDRs would be examined to determine if the user's telephony devices that conducted the telephony communications were located at the geographical area or areas specified in the discount criteria. This method could be conducted at the conclusion of a promotion to determine which, if any, users satisfied the discount criteria of the promotion.

In order to review such CDRs to determine of the telephony communications represented by those CDRs have satisfied criteria relating to a discount, it is necessary for the CDRs to include information that can be used to determine the location of the user's telephony device during the communication. Location information could be included in the CDRs, or information in the CDRs could be used to determine or infer the location of the user's telephony device.

For example, in some instances, the IP telephony system may receive location information from the user's telephony device during setup of a communication, while the communication is ongoing, or during teardown. The location information could be coordinates which are determined by a GPS receiver in the user's telephony device. When such information is received, it could be recorded as part of the CDR.

In many instances, a user's telephony device will gain access to a data network, such as the Internet, via a wireless access point such as a WiFi router. The IP address assigned to the wireless access point will appear as the “sent from” address in any data packets received by the IP telephony system from the user's telephony device. If the IP telephony system knows the geographical location of the device that has been assigned that IP address, the IP telephony system can assume that the user's telephony device is immediately adjacent that location. Thus, if the CDRs for a user's telephony communications include the IP address from which the communications originated, the originating IP address could be used to determine the location of the user's telephony device when the telephony communication was conducted.

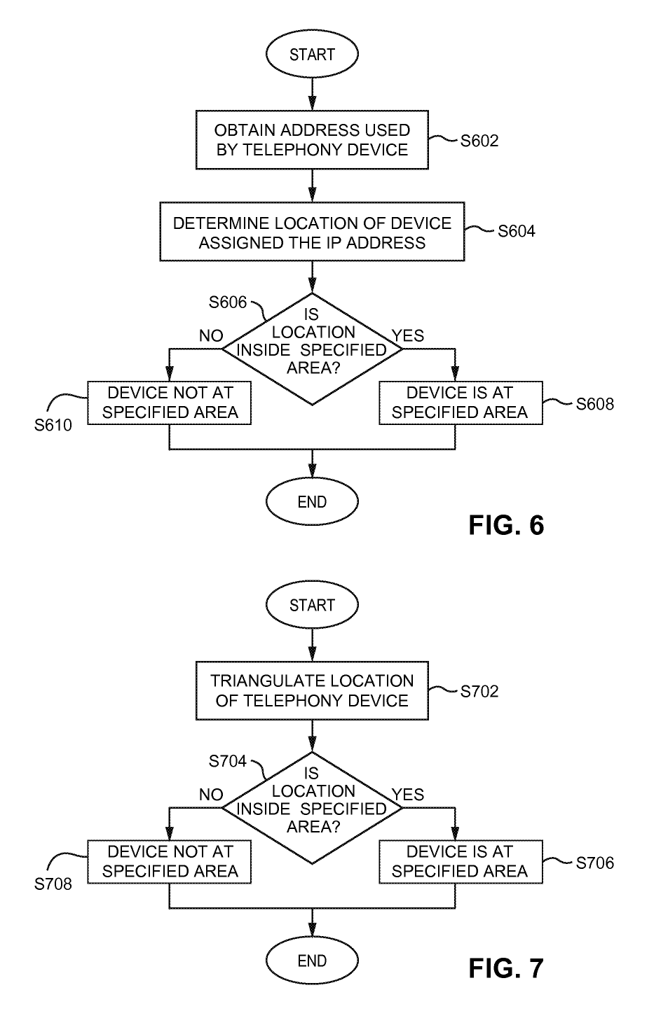

FIGS. 5-7, which are discussed below, illustrate methods which can be used to determine if a user's telephony device is located within the geographical area specified in the discount criteria of a promotion. The methods illustrated in FIGS. 5-7 could be performed during step S402 of the method illustrated in FIG. 4. The methods illustrated in FIGS. 5 and 6 could also be performed as part of a batch review of CDRs, as discussed above.

FIG. 5 illustrates steps of a first method embodying the invention for determining if one or more telephony devices are in a particular location. In particular, FIG. 5 shows a method in which the IP telephony system uses GPS data provided from the user's telephony device to determine the location of the telephony device, and whether it is within a location specified for running a promotion.

The method begins in step S502, when the IP telephony system 124 acquires the geographical location of the telephony device that is conducting a telephony communication by acquiring GPS data from the telephony device. The system can thus determine a latitude and longitude of the telephony device and determine the device's specific location. Upon determining the location of the telephony device, in step S504, the IP telephony system 124 determines if the user's telephony device was within a geographical area specified in the discount criteria.

The determination made in step S504 could be made in multiple different ways. For example, in some embodiments, the IP telephony system could have specific latitude and longitude coordinates of the center of the geographical area. The IP telephony system would then calculate a distance between that location, and the determined location of the user's telephony device. If the distance is less than a threshold distance, the method proceeds to step S506, and the IP telephony system determines that the user's telephony device is within the specified geographical area. If not, the method proceeds to step S508, and the IP telephony system determines that the user's telephony device was not within the specified geographical area.

In alternate embodiments, the IP telephony system could have a range of latitude values and a range of longitude values that define the specified geographical area. In this instance, in step S504, the IP telephony system would determine if the latitude and longitude values indicating the position of the user's telephony device both fall with the ranges of the specified geographical area. If so, the method proceeds to step S506, and the IP telephony system determines that the user's telephony device is within the specified geographical area. If not, the method proceeds to step S508, and the IP telephony system determines that the user's telephony device was not within the specified geographical area.

Of course, other methods could also be used in step S504 to determine if the location of the user's telephony device falls within the specified geographical area.

As noted above, the method steps illustrated in FIG. 5 would be part of a determination that is made in step S402 of the method illustrated in FIG. 4. Thus, once a determination is made in either step S506 or S508, the method illustrated in FIG. 4 would continue in step S404.

FIG. 6 illustrates steps of a second method embodying the invention for determining if one or more telephony devices are in a certain location. Here again, this method would be performed as part of step S402 in the method illustrated in FIG. 4. In this method, the IP telephony system 124 utilizes an IP address listed in the data packets sent from the user's telephony device while conducting a telephony communication. As explained above, the user's telephony device may use a wireless access point to access the Internet in order to conduct the telephony communication. In that situation, the communications sent from the user's telephony device to the IP telephony system will list the IP address assigned to the wireless access point as the originating address.

In step S602, the IP telephony system obtains the IP address of the data packets being received from the user's telephony device. In step S604, the IP telephony system uses the IP address to determine which wireless access point is assigned the IP address, and the physical location of that wireless access point. This would likely involve maintaining a database of wireless access point, and their physical locations. Because the IP addresses assigned to a wireless access point will vary over time, it would be necessary to keep such a database constantly updated.

Next, in step S606 the IP telephony device determines if the location of the wireless access point to which the IP address is assigned is located within the geographical area specified in the discount criteria. This could be done in any of multiple different ways.

If the GPS coordinates of the wireless access point are known, the determination could be made in the ways discussed above in connection with FIG. 5. If a street address is provided for the wireless access point, it would be necessary for the IP telephony system to compare that street address to the geographical area specified in the discount criteria.

If the determination made in step S606 indicates that the wireless access point is within the specified geographical area, the method proceeds to step S608, and the IP telephony system determines that the user's telephony device is within the specified geographical area. If not, the method proceeds to step S610, and the IP telephony system determines that the user's telephony device was not within the specified geographical area.

In other embodiments, part of the information gathered and recorded for a particular promotion could include the IP addresses of any wireless access points that are present at the geographical area specified for the promotion. In this instance, it might not be necessary for the IP telephony system to consult a large database to determine the location that corresponds to a particular IP address. Instead, the IP telephony system would only need to know if the IP address of the data packets being sent from a user's telephony device match the known IP addresses of the wireless access points at the location of the promotion.

As noted above, the method illustrated in FIG. 6 would be part of a determination made in step S402 of the method illustrated in FIG. 4. Thus, after a determination is made in step S608 or S610, the method illustrated in FIG. 4 would proceed to step S404.

FIG. 7 illustrates steps of a third method embodying the invention for determining if one or more telephony devices are in a particular location. In this method, the cellular signal being transmitted from a user's telephony device is used to triangulate the location of the telephony device. Thus, this method might be particularly useful if the user's telephony device is using a data channel provided by a cellular service provider to conduct a telephony communication through the IP telephony system.

The method begins in step S702, when the cellular signal being transmitted from a user's telephony device is used to triangulate the position of the user's telephony device. This may require the active involvement of one or more cellular service providers. However, the techniques and methods used to triangulate the position of a cellular telephone are well known to those of ordinary skill in the art. Step S702 may only involve obtaining a triangulated position from a cellular carrier. Alternatively, step S702 may involve requesting such information, and then waiting for a response from a cellular carrier.

In some instances, it may be necessary to conduct the triangulation step in real time, while the user's telephony device is engaged in the telephony communication. In other instances, it may be possible to obtain this information from a cellular carrier after the telephony communication has ended.

Next, in step S704, the IP telephony system determines if the location of the user's telephony device is within the geographical area specified in the discount criteria. This determination can be made using any of the methods described above.

If the determination made in step S704 indicates that the user's telephony device was within the specified geographical area, the method proceeds to step S706, and the IP telephony system determines that the user's telephony device is within the specified geographical area. If not, the method proceeds to step S708, and the IP telephony system determines that the user's telephony device was not within the specified geographical area.

The method illustrated in FIG. 6 would be performed as the determination step S402 in the method illustrated in FIG. 4. Thus, once a determination is made in step S706 or S708, the method illustrated in FIG. 4 would proceed to step S404.

It should be appreciated that there are other various ways in which the location of a user's telephony device could be determined. For example, the telephony device may be configured to access one or more location based social networking services, such as FourSquare®. When the telephony device “checks-in” to a particular location, the IP telephony system 124 can determine if the telephony device is at or near the specific location based upon the location where the device is “checked-in.”

It should also be appreciated that discount criteria for a promotion may not be limit the discount so that it applies only to the telephony communications that are conducted during the promotion time period. For example, the discount criteria can be configured such that if the user conducts a telephony communication during the promotional time period, the user receives a discount on telephony services provided outside the promotional time period. Using the example above, if a user conducted a telephony communication between the hours of 5 PM to 7 PM at specified coffee shop, then the user may receive further discounts for telephony communications that are conducted any time during the five days following the promotion. Of course, the duration can be configured in a variety of ways and is in no way only limited to a number of days.

The IP telephony system may also send messages to user telephony devices to inform the users that a promotion will take place at a given location for a given period of time. These messages can be sent to the telephony devices via push notifications, text messages, email messages, and/or multimedia messages. Of course, the messages can be sent to the devices in any other number of ways and are in no way limited to the above-mentioned group.

Such messages could be sent at any time. But the messages would likely be more effective if they are sent just before or during the time of the promotion. Likewise, such messages could be sent to all system users. But the messages might be particularly effective if they are sent only to user telephony devices that are already near to the geographical area(s) where the promotions will occur. For example, the IP telephony system could send such a message to a user's phone if the IP telephony system becomes aware that the user is moving towards the location where such a promotion will occur.

Using the example above, the IP telephony service provider could send a push notification to the telephony device of a user indicating that if the user places a phone call through the IP telephony system at any of a chain of coffee shops between the hours of 5 PM to 7 PM, the user will receive a 50% discount on the phone call. Likewise, the IP telephony system provider may be able to detect the location of a user's telephony device using any one of the means mentioned above. If the user's telephony device is near a location that is running the promotion, the IP telephony system could then send a message to the user's telephony device regarding the promotion.

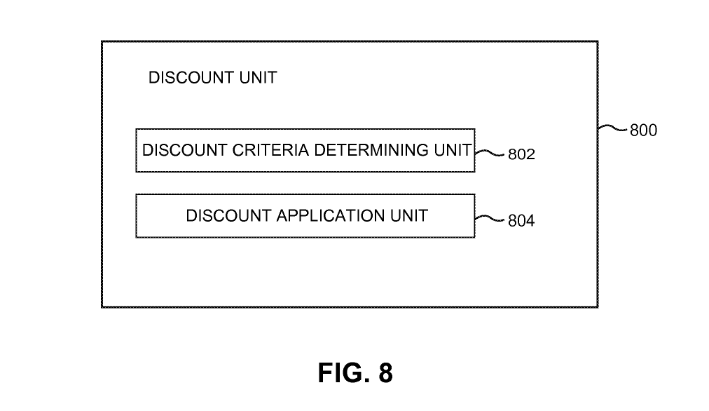

FIG. 8 illustrates a discount unit 800 which could be part of an IP telephony system, and which could perform the methods discussed above. The discount unit 800 includes a discount criteria determining unit 802 which would be responsible for determining if discount criteria have been satisfied. Also, a discount application unit 804 would be responsible for applying any discounts if the discount criteria determining unit decides that discount criteria have been satisfied.

While foregoing is directed to embodiments of the present technology, other and further embodiments of the technology may be devised without departing from the basic scope thereof, and the scope thereof.

1. A method implemented in an Internet Protocol (IP) telephony system having one or more processors for deciding whether to provide discounted telephony services to a user of the IP telephony system, the method comprising:
determining, via the one or more processors, whether discount criteria have been satisfied relating to a location at which the user's telephony device is or was involved in a telephony communication via the IP telephony system; and
deciding to provide the user with discounted telephony services if the determining step indicates that the discount criteria have been satisfied.

2. The method of claim 1, wherein the determining step comprises determining if the user's telephony device sent or received at least one telephony communication via the IP telephony system while located within a first geographical area.

3. The method of claim 2, wherein the determining step further comprises:
acquiring geographical coordinate data indicative of a location of the user's telephony device when the user's telephony device sends or receives telephony communications via the IP telephony system; and
determining if the geographical coordinate data indicates that the user's telephony device was within the first geographical area when at least one telephony communication was sent or received by the user's telephony device via the IP telephony system.

4. The method of claim 3, wherein determining if the user's telephony device sent or received at least one telephony communication via the IP telephony system while located within the first geographical area comprises:
determining a boundary of the first geographical area; and
determining if the acquired geographical coordinate data indicates that the user's telephony device was within the geographical boundary of the first geographical area when at least one telephony communication was sent or received by the user's telephony device via the IP telephony system.

5. The method of claim 2, wherein determining if the user's telephony device sent or received at least one telephony communication via the IP telephony system while located within the first geographical area comprises:
determining an IP address that was used by the user's telephony device to communicate with the IP telephony system to send and receive a telephony communication via the IP telephony system; and
determining if the IP address corresponds to an IP address that has been assigned to a communications device that is located within the first geographical area.

6. The method of claim 2, wherein determining if the user's telephony device sent or received at least one telephony communication via the IP telephony system while located within the first geographical area comprises:
triangulating a position of the user's telephony device when the user's telephony device sends or receives a telephony communications; and
determining if the triangulated position of the user's telephony device is within the first geographical area.

7. The method of claim 1, wherein the discount criteria also relate to a time during which the user's telephony device was involved in the telephony communication.

8. The method of claim 7 wherein the determining step further comprises determining if the user's telephony device sent or received at least one telephony communication during a first time period.

9. The method of claim 2, further comprising sending a push notification to one or more telephony devices when the telephony devices are determined to be near the first geographical area, the push notification resulting in users of the one or more telephony devices being informed of the discount criteria for obtaining discounted telephony services.

10. The method of claim 2, further comprising sending a text message to one or more telephony devices when the telephony devices are determined to be near the first geographical area, the text message informing users of the telephony devices of the discount criteria for obtaining discounted telephony services.

11. The method of claim 2, further comprising sending an email message to one or more telephony devices when the telephony devices are determined to be near the first geographical area, the email message informing the users of the telephony devices of the discount criteria for obtaining discounted telephony services.

12. The method of claim 2, wherein the deciding step comprises deciding to provide the user with a discount only for telephony communications sent and received from within the first geographical area.

13. The method of claim 12, wherein the discount criteria also relate to a time during which the user's telephony device was involved in the telephony communication, wherein the determining step further comprises determining if the user's telephony device sent or received at least one telephony communication during a first time period, and wherein the deciding step comprises deciding to provide the user with a discount only for telephony communications sent and received from within the first geographical area during the first time period.

14. The method of claim 2, further comprising determining how many different telephony devices sent or received telephony communications via the IP telephony system while located within the first geographical area, and wherein the deciding step results in a decision to provide the user with discounted telephony services if the determined number of different telephony devices is greater than a threshold value.

15. The method of claim 2, further comprising further comprising determining how many different telephony devices sent or received telephony communications via the IP telephony system during a first time period while located within the first geographical area, and wherein the deciding step results in a decision to provide the user with discounted telephony services if the determined number of different telephony devices is greater than a threshold value.

16. The method of claim 1, wherein the determining step comprises determining if the user's telephony device sent or received a telephony communication from within at least one of a plurality of different geographical areas.

17. The method of claim 1, wherein the deciding step comprises deciding to provide the user with discounted telephony services for telephony communications conducted through the IP telephony system from any location if the determining step indicates that the discount criteria has been satisfied.

18. The method of claim 1, further comprising receiving a communication from one or more telephony devices, the communication indicating a desire to receive a discount on telephony services.

19. The method of claim 1, wherein a location of the user's telephony device is determined using information relating to a check-in performed by the user's telephony device using a location based social networking service, and wherein that determined location is used to determine if the user's telephony device was located within a first geographical area when the user's telephony device sent or received at least one telephony communication via the IP telephony system.

20. A system for deciding whether to provide discounted telephony services to a user of the IP telephony system, comprising:
means for determining whether discount criteria have been satisfied relating to a location at which the user's telephony device is or was involved in a telephony communication via the IP telephony system; and
means for deciding to provide the user with discounted telephony services if the determining means indicates that the discount criteria have been satisfied.

21. A system for deciding whether to provide discounted telephony services to a user of the IP telephony system, comprising:
a discount criteria determining unit that determines whether discount criteria have been satisfied relating to a location at which the user's telephony device is or was involved in a telephony communication via the IP telephony system; and
a discount application unit that decides to provide the user with discounted telephony services if the discount criteria determining unit indicates that the discount criteria have been satisfied.

22. The system of claim 21, wherein the discount criteria determining unit determines if the user's telephony device sent or received at least one telephony communication via the IP telephony system while located within a first geographical area.

23. The system of claim 21, wherein the discount criteria also relate to a time during which the user's telephony device was involved in the telephony communication.

24. The system of claim 23, wherein the discount criteria determining unit determines if the user's telephony device sent or received at least one telephony communication during a first time period.
